(19) United States
(12) Patent Application Publication
(10) Pub. No.: US 2016/0150334 A1
(43) Pub. Date: May 26, 2016

(54) APPARATUS AND METHOD FOR TESTING ACOUSTIC DEVICES

(71) Applicants: Fu Tai Hua Industry (Shenzhen) Co., Ltd., Shenzhen (CN); HON HAI PRECISION INDUSTRY CO., LTD., New Taipei (TW)

(72) Inventors: WEI-CHIANG LIN, New Taipei (TW); LI-JUN LI, Shenzhen (CN)

(21) Appl. No.: 14/587,329

(22) Filed: Dec. 31, 2014

(30) Foreign Application Priority Data
Nov. 26, 2014 (CN) 201410690947.X

(51) Int. Cl. H04R 29/00

(52) U.S. Cl. CPC H04R 29/001; H04R 2499/11

(57) ABSTRACT

An apparatus for testing an acoustic device of a mobile terminal includes a bracket, a sound generator, a driving device, a sealing member connected to the driving device, and a plurality of first reference microphones. The driving device includes a first driving member and a second driving member. The first driving member is capable of driving the second driving member move along a first direction, and the second driving member is capable of driving the sealing member move along a second direction substantially perpendicular to the first direction, such that the sealing member is capable of moving toward or away from the acoustic device. The first reference microphones are mounted on the bracket and configured to test an leakproofness of the acoustic device when the acoustic device is sealed by the sealing member. A method for testing the acoustic device is also provided.

### FIELD

The subject matter herein generally relates to an apparatus and a method for testing acoustic devices.

### BACKGROUND

Mobile terminals, such as mobile phones and tablet personal computers, can include acoustic devices. The acoustic devices can be microphones and speakers. However, if there are air leakages in the acoustic devices, the acoustic devices can receive noise in the mobile terminal, and the quality of the acoustic device can be influenced. Therefore, the leakproofness of the acoustic devices in the mobile terminals needs to be tested. Moreover, the audio quality of the acoustic devices also needs to be evaluated.

### BRIEF DESCRIPTION OF THE DRAWINGS

Implementations of the present technology will now be described, by way of example only, with reference to the attached figures.

FIG. 1 is an isometric view of one embodiment of an apparatus for testing an acoustic device.

FIG. 2 is an exploded, isometric view of the apparatus in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described.

Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” when utilized, means “including, but not necessarily limited to”; it specifically indicates open-ended inclusion or membership in the so-described combination, group, series and the like.

The present disclosure is described in relation to an apparatus and method for testing leakproofness and evaluating audio quality of aquatics devices in mobile terminals. The aquatics device can include one or more microphones and speakers.

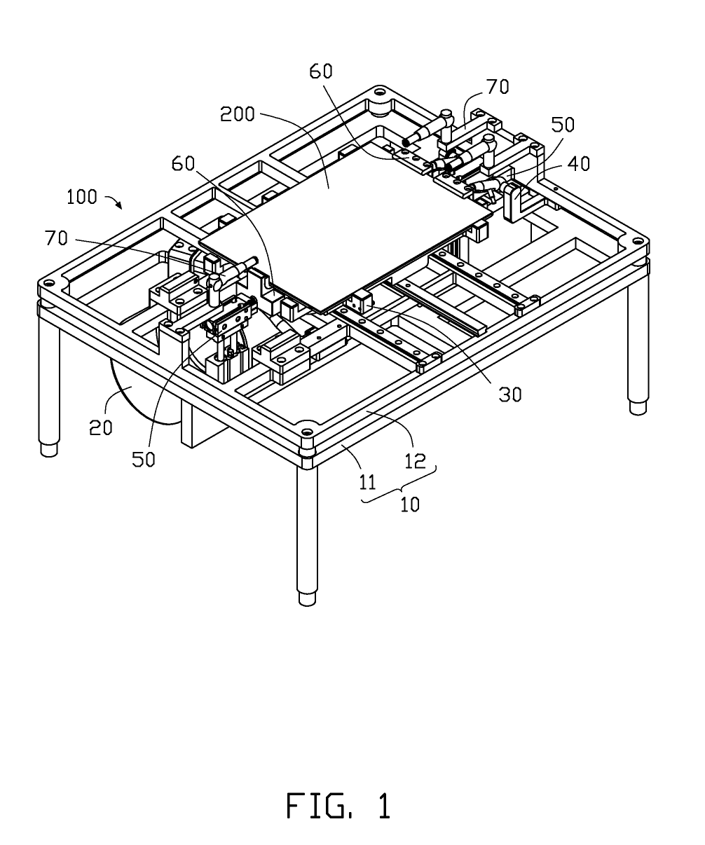

FIG. 1 illustrates that an apparatus 100 for testing an acoustic device can include a bracket 10, an audio generator 20, a tray 30, a plurality of first reference microphones 40, a driving device 50, a sealing member 60, and a plurality of second reference microphones 70. The apparatus 100 can further include a shielding box (not shown). The shielding box can receive the audio generator 20, the tray 30, the first reference microphones 40, and the second reference microphones 70, such that the apparatus 100 would not be interfered by external noise.

The bracket 10 can include a base 11 and a test board 12 mounted on the base 11.

The audio generator 20 can be mounted on the base 11 and positioned below the test board 12. The audio generator 20 can be capable of generating signals representing sounds. The tray 30 can be mounted on the test board 12 in a sliding way. A testing mobile terminal 200 having the acoustic device (not shown) can be positioned in the tray 30. The acoustic device can include one or more microphones and speaker.

The first reference microphones 40 can be mounted on the base 11 adjacent to the acoustic devices. In at least one embodiment, one of the second reference microphones 70 can be positioned near the microphone of the testing mobile terminal 200, and two of the first reference microphones 40 can be positioned near the speakers of the testing mobile terminal 200. The first reference microphones 40 can be configured to test a leakproofness of the acoustic devices when the acoustic devices are sealed by the sealing member 60.

The driving device 50 can be mounted on the base 11 and connected to the sealing member 60. The driving device 50 can drive the sealing member 60 to move toward or away from the acoustic device. When the testing mobile terminal 200 moved to the central portion of the test board 12, the sealing member 60 can be closely attached to the acoustic devices, and the testing mobile terminal acoustic device can be sealed.

The second reference microphones 70 can be mounted on two opposite sides of the test board 12 and on the top of the first reference microphones 40. When the testing mobile terminal 200 in the tray 30 moved to the central portion of the test board 12, each of the second reference microphones 70 can be positioned adjacent to one of the acoustic devices. The second reference microphones 70 can be configured to evaluate an audio quality of the acoustic device.

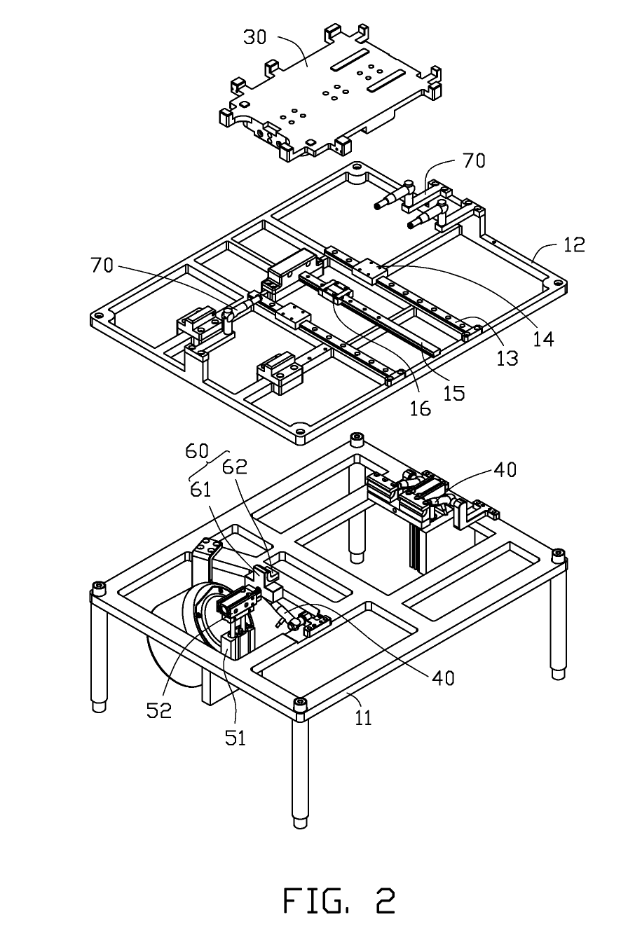

FIG. 2 illustrates that the driving device 50 can include a first driving member 51 and a second driving member 52. The first driving member 51 can be mounted on the base 11 and capable of driving the second driving member 52 to move along a first direction. One end of the second driving member 52 can be connected to the first driving member 51, and the other end of the second driving member 52 can be connected to the sealing member 60. The second driving member 52 can drive the sealing member 60 to move along a second direction substantially perpendicular to the first direction. In at least one embodiment, the first direction can be substantially perpendicular to the test board 12. The second direction can be substantially parallel to the test board 12. The first driving member 51 and the second driving member 52 can be, but not limited to, cylinders.

The sealing member 60 can include a connecting member 61 and a sealing foam 62. The connecting member 61 can be connected to the second driving member 52, and the sealing foam 62 can be received in the connecting member 61. In at least one embodiment, the apparatus 100 can include two driving devices 50 and two sealing members 60. One sealing member 60 can be configured to seal the microphone, and the other sealing member 60 can be configured to seal the speakers. The sealing member 60 corresponding to the speakers can include two sealing foams 62 received in the connecting member 61. In other embodiments, the sealing foam 62 can be connected to the connecting member 61.

The test board 12 can include a pair of rails 13 and a guiding rail 14 positioned between the rails 13. The rails 13 and the guiding rail 14 can extend from an edge to the central portion of the test board 12. The test board 12 can further include a pair of sliding blocks 15 arranged on the rails 13, and a third driving member 16 arranged on the guiding rail 14. The third driving member 16 can slide on the guiding rail 14. The tray 30 can be connected to the two sliding blocks 15 and the third driving member 16, such that the tray 30 can move along the rails 13 when driven by the third driving member 16. Therefore, the tray 30 can slide on the test board 12 to transport the testing mobile terminals 200 (as shown in FIG. 1).

In assembling, the sound generator 20, the first reference microphones 40, and the driving device 50 can be mounted on the base 11, and the sealing member 60 can be connected to the driving devices 50. Then, the test board 12 can be mounted on the base 11, and the second reference microphones 70 can be mounted on the test board 12. After that, the tray 30 can be connected to the rails 13 on the test board 12, and the apparatus 100 for testing an acoustic device 100 be assembled.

A method for testing the acoustic device may include steps as follows. First, the tray 30 may move to the edge of the test board 12 driven by the third driving member 16, and the testing mobile terminal 200 can be put in the tray 30. The tray 30 can move to the central portion of the test board 12, and the shielding box is closed. The sound generator 20 can provide sound signals, and the audio quality can be evaluated by the second reference microphones 70. Next, the second driving member 52 may move toward the test board 12 driven by the first driving member 51, and then the sealing member 60 can move toward the testing mobile terminal 200 driven by the second driving member 52, until the sealing members 60 are closely attached to the acoustic device. When the acoustic devices are sealed by the sealing members 60, the sound generator 20 can provide sound signals, and the leakproofness of the acoustic devices can be tested by the first reference microphones 40. Then the tray 30 may move to the edge of the test board 12 with the testing mobile terminal 200, and next testing mobile terminal 200 can be put in the tray 30 for testing.

The apparatus 100 can include the first reference microphones 40 for testing the leakproofness of the acoustic device and the second reference microphones 70 for evaluating the audio quality of the acoustic device, so the test efficiency can be improved than the testing apparatus including only one kind of the reference microphones. The apparatus 100 can include the driving device 50, and the sealing member 60 can move toward or away from the acoustic devices. Therefore, the audio quality test would not be interfered by the sealing member 60. The apparatus 100 can test the leakproofness and the audio quality of the acoustic devices. There is no need to transfer the testing mobile terminals for doing the tests, so the testing mobile terminals would not be scratched.

The embodiments shown and described above are only examples. Many details are often found in the art such as the other features of an apparatus and a method for testing an acoustic device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including, the full extent established by the broad general meaning of the terms used in the claims. It will therefore be appreciated that the embodiments described above may be modified within the scope of the claims.

What is claimed is:

1. An apparatus for testing an acoustic device of a mobile terminal, comprising:
a bracket;
a sound generator mounted on the bracket;
a driving device mounted on the bracket, the driving device having a first driving member and a second driving member;
a sealing member connected to the second driving member; the first driving member is capable of driving the second driving member move along a first direction, and the second driving member is capable of driving the sealing member move along a second direction substantially perpendicular to the first direction, such that the sealing member is capable of moving toward or away from the acoustic device; and
a plurality of first reference microphones mounted on the bracket, the first reference microphones are configured to test an leakproofness of the acoustic device when the acoustic device is sealed by the sealing member.

2. The apparatus as claimed in claim 1, wherein the apparatus further comprises a plurality of second reference microphones configured to test a audio quality of the acoustic device; and
wherein the one or more second reference microphones are mounted on the bracket, and positioned on top of the one or more first reference microphones.

3. The apparatus as claimed in claim 1, wherein the sealing member includes a connecting member and a sealing foam; the connecting member is connected to the second driving member, and the sealing foam is received in the connecting member.

4. The apparatus as claimed in claim 1, wherein the bracket includes a base and a test board mounted on the base.

5. The apparatus as claimed in claim 4, wherein the apparatus further includes a tray configured to transport the mobile terminal, and the tray is mounted on the test board in a sliding way.

6. The apparatus as claimed in claim 5,
wherein the test board includes a pair of rails and a guiding rail positioned between the rails;
wherein the test board further includes a third driving member connected to the guiding rail, and a pair of sliding blocks connected to the rails; and
wherein the ray is connected to the third driving member and the sliding blocks.

7. A method for testing an acoustic device of a mobile terminal, comprising:
placing the mobile terminal in a tray on a bracket;
providing a sound signal by a sound generator;
testing a audio quality of the acoustic device by a plurality of second reference microphones;
driving a sealing member to move toward the acoustic device until the acoustic device is sealed by the sealing member; and
testing a leakproofness of the acoustic device by a plurality of first reference microphones.

8. The method as claimed in claim 7, wherein the sealing member includes a connecting member and a sealing foam connected to the connecting member.

9. The method as claimed in claim 7, wherein the bracket comprises a base and a test board mounted on the base, and the tray is mounted on the test board in a sliding way.

10. The method as claimed in claim 9, wherein the first reference microphones are mounted on the base, and the second reference microphones are mounted on the test board.

11. The method as claimed in claim 9,
wherein the sealing member is connected to a driving device mounted on the base;
wherein the driving device comprises a first driving member and a second driving member; and
wherein the first driving member is capable of driving the second driving member to move along a first direction, and the second driving member is capable of driving the sealing member to move along a second direction substantially perpendicular to the first direction.

12. The method as claimed in claim 9,
wherein the test board includes a pair of rails and a guiding rail positioned between the rails;
wherein the test board further includes a third driving member connected to the guiding rail, and a pair of sliding blocks connected to the rails; and
wherein the tray is connected to the third driving member and the sliding blocks.
